(19) United States
(12) Patent Application Publication
(10) Pub. No.: US 2012/0237048 A1
(43) Pub. Date: Sep. 20, 2012

(54) APPARATUS AND METHOD FOR ECHO SUPPRESSION

(75) Inventors: David Barron, Scottsdale, AZ (US); Suat Yeldener, Whitestone, NY (US)

(73) Assignee: CONTINENTAL AUTOMOTIVE SYSTEMS, INC., Deer Park, IL (US)

(21) Appl. No.: 13/046,922

(22) Filed: Mar. 14, 2011

(51) Int. Cl. G10K 11/16

(52) U.S. Cl. 381/71.1

(57) ABSTRACT

An input signal from the input source is received. An attenuation of an echo canceller filter is calculated using at least the input signal. A spectral component of a frequency band of an echo suppressor is adjusted to perform enhanced suppression using the calculated attenuation. A comfort noise factor is calculated using at least the input signal and the calculated attenuation. The comfort noise to the output of the echo suppressor is adjusted to obtain a modified input signal.

### FIELD OF THE INVENTION

The invention relates generally to the suppression of echoes using echo suppressors.

### BACKGROUND OF THE INVENTION

Different types of audio signals are received at and sent from vehicles. For instance, downlink signals are received from some other location. Uplink signals are sent from a vehicle to some other destination. Speakers broadcast the downlink speech signals that are received, and microphones receive the speech of occupants in the vehicle for transmission. As different speech signals are transmitted and received, these signals may be reflected in the vehicle or at other places, and echoes can occur. The presence of echoes degrades the quality of speech for listeners and echo cancellers have been developed to attenuate echoes.

Acoustic echo cancellers are typically used in vehicles as part of hands-free equipment due to the close proximity of loud speakers with open microphones. However, echo cancellers can typically provide only a portion of the cancellation required in vehicular environments because of the high coupling between the loud speakers and the microphones. As a result, echo suppression approaches are used in addition to echo cancellers to increase the attenuation of echoes to an acceptable level.

Unfortunately, previous echo suppression approaches have suffered from a variety of different problems. Distortion in the uplink speech can occur during double talk (i.e., speakers at the vehicle and the far end speaking at the same time) and this distortion is often a result of broad band attenuation that is applied to the uplink signal that is used to reduce echo to an acceptable level.

Noise floor modulation can be caused by broad band based attenuation that modulates the noise floor due to the on/off nature of the echo suppressor. As used herein, “noise floor” refers to the estimated power level of the ambient or background noise in the vehicle (as contained, for example, in the microphone signal). This effect is a particularly disadvantageous effect since this modulation is then passed on to the noise suppression algorithm that may be in use in the system. And, noise suppression approaches are especially sensitive to modulation thereby reducing the performance of the noise suppressor.

Consequently, previous approaches have not been sufficient to attenuate echo to an acceptable level thereby leading to significant user dissatisfaction with these previous approaches.

### BRIEF DESCRIPTION OF THE DRAWINGS

The present invention is illustrated, by way of example and not limitation, in the accompanying figures, in which like reference numerals indicate similar elements, and in which:

FIG. 1 comprises a block diagram of a system for echo suppression according to various embodiments of the present invention;

FIG. 2 comprises a block diagram of a system for echo suppression according to various embodiments of the present invention;

FIG. 3 comprises a block diagram of a system for echo suppression using a parallel configuration of devices according to various embodiments of the present invention;

FIG. 4 comprises a flowchart of one example of an approach for echo suppression according to various embodiments of the present invention;

FIG. 5 comprises a diagram showing insertion of comfort noise in the frequency domain according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

In the approaches described herein, a comfort noise suppressor is integrated with an echo canceller in the frequency domain to reduce or eliminate the effects of broad band attenuation on uplink speech signals. By performing these functions in the frequency domain, the effects of broad band attenuation are focused in the frequency range where improvement is needed and comfort noise can be inserted into the same area to compensate for the induced modulation.

In many of these embodiments, an input signal from the input source is received. An attenuation of an echo canceller filter is calculated using at least the input signal. A spectral component of a frequency band of an echo suppressor is adjusted to perform enhanced suppression using the calculated attenuation. A comfort noise factor is also calculated using at least the input signal and the calculated attenuation. The comfort noise to the output of the echo suppressor is adjusted to obtain a modified input signal.

In some aspects, the attenuation is calculated using an echo return loss enhancement (ERLE) algorithm. In other aspects, the calculation of the attenuation and the application of the attenuation occur at a plurality of frequency bands and the echo suppressor comprises a plurality of echo suppressors with a selected echo suppressor from the plurality of echo suppressors configured to suppress echo on one of the plurality of frequency bands.

In some other aspects, comfort noise is generated by convolving a spectral image of background noise with white noise. In still other aspects, calculating the attenuation and calculating the comfort noise are performed in the frequency domain.

In some examples, the echo canceller filter and the echo suppressor are disposed in a vehicle. In other aspects, the input signal is a microphone signal to be sent to an uplink receiver. In still other aspects, the input signal is a downlink signal received from a transmitter.

In others of these embodiments, an apparatus for providing echo suppression for signals received from an input source includes an interface and a controller. The interface has an input and output, and the input is configured to receive an input signal from the input source.

The controller is coupled to the interface and is configured to calculate an attenuation of an echo canceller filter using at least the input signal that is effective to adjust a spectral component of a frequency band of an echo suppressor to perform enhanced suppression using the calculated attenuation. The controller is further configured to calculate a comfort noise factor using at least the input signal and the calculated attenuation and to apply the comfort noise to the output of the echo suppressor. The application of the comfort noise is effective to obtain a modified input signal at the output of the echo suppressor.

In some aspects, the attenuation is calculated using an echo return loss enhancement (ERLE) algorithm. Generally speaking, ERLE algorithms perform and obtain a measurement of the loss through the echo cancelling filter. This ERLE measurement is the input (microphone) power divided by the output (error) power. In other aspects, the controller calculates attenuation at a plurality of frequency bands and the echo suppressor comprises a plurality of echo suppressors with a selected echo suppressor from the plurality of echo suppressors configured to suppress echo on one of the plurality of frequency bands. In still other aspects, the controller generates the comfort noise by convolving a spectral image of background noise with white noise.

In some examples, the controller calculates the attenuation and calculates the comfort noise in the frequency domain. In other examples, the apparatus is disposed in a vehicle. In other examples, the input signal is a microphone signal that is to be sent to an uplink receiver. In yet other examples, the input signal is a downlink signal received from a transmitter.

In still others of these embodiments, a system for providing echo suppression for signals received from an input source includes an echo suppressor and an echo suppression adjustment device. The echo suppression adjustment device is coupled to the echo suppressor and the echo suppression device includes an interface and a controller. The interface has an input and output and the input is configured to receive a microphone signal. The controller is coupled to the interface and is configured to calculate an attenuation of an echo canceller filter using at least the microphone signal and adjust a spectral component of a frequency band of the echo suppressor to perform enhanced suppression using the calculated attenuation. The controller is further configured to calculate a comfort noise factor using at least the microphone signal and the calculated attenuation and to add the comfort noise to the output of the echo suppressor to obtain a modified microphone signal at the output of the echo suppressor.

In some aspects, the attenuation is calculated using an echo return loss enhancement (ERLE) algorithm. In other aspects, the controller calculates attenuation at a plurality of frequency bands and the echo suppressor comprises a plurality of echo suppressors with a selected echo suppressor from the plurality of echo suppressors configured to suppress echo on one of the plurality of frequency bands. In still other aspects, the controller generates the comfort noise by convolving a spectral image of background noise with white noise.

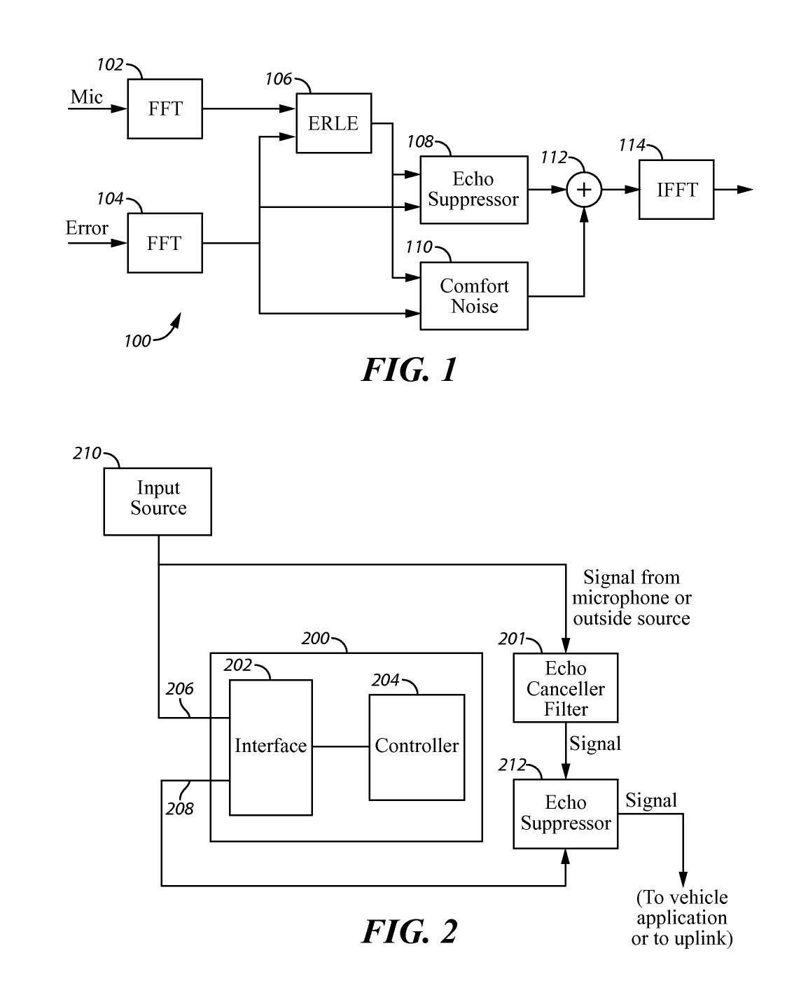

Referring now to FIG. 1, a system 100 includes a first fast Fourier transformer (FFT) 102, a second FFT 104, an Echo Return Loss Enhancement (ERLE) device 106, an echo suppressor 108, a comfort noise generator 1010, a summer 112, and an inverse FFT (IFFT) 114.

The first FFT block 102 and the second FFT block 104 calculate the fast Fourier transforms of a microphone signal and an error signal. More specifically, FFT block 102 and FFT block 104 convert the received signals from the time domain to the frequency domain. The microphone signal is one of the inputs to the echo canceller (the other being the reference signal) and the error signal is the output of the echo canceller (microphone signal with the echo cancelled). The error signal represents the output of the echo canceller and is an adaptive filter output. Generally speaking, the reference signal is filtered by the adaptive filter's coefficients and the result is then subtracted from the microphone signal to produce the error signal.

The ERLE device 106 calculates an attenuation. The echo suppression algorithm assumes that the echo canceller filter will provide accurate information as to when echo is present via the Echo Return Loss Enhancement (ERLE) measure. The assumption is that if echo is present, the ERLE will be greater than approximately 0 dB. In other words, there is some loss through the echo canceller filter due to echo cancellation. This holds true unless there is an interfering signal present in the uplink signal, such as speech, as in the case of double talk. During double talk, the ERLE typically drops to almost zero indicating no echo present. This is typically a desirable feature because it provides a mechanism to reduce the applied attenuation during double talk in a very natural way.

The echo suppression algorithm can apply attenuation to the uplink signal based on the inverse of the ERLE measurement and not be concerned whether there is uplink speech present. This approach will attenuate the uplink signal more during high levels of ERLE. High levels of ERLE are the result of strong downlink single talk with low ambient noise where the filter can converge to a very accurate representation of the environment. This situation often indicates that extra echo suppression is needed because in a quiet environment even low level echo can be perceived as annoying to listeners.

Applying these approaches in the frequency domain improves the echo suppression due to the frequency dependent application. These approaches estimate the ERLE of each subband, or frequency block, independently and then calculate the associated attenuation factor for each individual subband:

$${G}_{es} = \frac{1}{E R L E}$$

As mentioned above, the measured ERLE of the filter drops to almost zero during periods of double talk. This reduces the attenuation that is applied during double talk, thereby reducing the amount of distortion introduced into the uplink speech by the echo suppressor. This occurrence allows a small amount of echo through during the double talk activity but it is less perceptible due to the masking quality of uplink speech.

Consequently, one benefit of the present approaches is that improved echo cancellation is provided (as compared to previous approaches) where (e.g., in particular frequency or spectral bands) it is needed the most and less distortion in the uplink speech during double talk occurs.

The comfort noise generator 110 generates comfort noise. In one approach, comfort noise is generated by convolving the spectral image of a smoothed background noise estimator with white noise. This provides spectral shaping to the white noise and produces a pleasant sounding noise that is perceptually similar to the original background noise.

Comfort noise is inserted into each frequency block on an individual basis to offset the echo suppressor's applied attenuation at block 112. The comfort noise is applied as the inverse of the echo suppressor's attenuation factor as shown below:

G_{cn}=ERLE

This gain factor is then applied to the same spectral components of the comfort noise as the associated echo suppressor and the result is summed together at block 112 with the suppressor's output. An inverse fast Fourier transform is taken at block 114 to return the signal to the time domain.

It will be appreciated that integrating the echo suppressor together with the comfort noise generator in the frequency domain reduces distortion caused by the suppression of echo by focusing the attenuation where it is needed and reduces noise modulation by directly compensating for the loss in the same frequency range.

Referring now to FIG. 2, an apparatus 200 for providing echo suppression for signals received from an input source (e.g., an uplink source outside the vehicle or a microphone in the vehicle) includes an interface 202 and a controller 204. The interface 202 has an input 206, and an output 208. The input 206 is configured to receive an input signal from the input source 210 (e.g., an uplink source or a microphone).

The controller 204 is coupled to the interface 202 and is configured to calculate an attenuation of an echo canceller filter 201 using at least the input signal that is effective to adjust a spectral component of a frequency band of an echo suppressor 212 to perform enhanced suppression using the calculated attenuation. The controller 204 is further configured to calculate a comfort noise factor using at least the input signal and the calculated attenuation and to apply the comfort noise to the echo suppressor 212 via the output 208. The application of the comfort noise is effective to obtain a modified input signal at the output of the echo suppressor 212. The output of the echo suppressor 212 is sent to a vehicular (e.g., hands-free) application (if from an uplink source) or to an uplink destination (if from a microphone in the vehicle) via some transmission device.

In some aspects, the attenuation is calculated using an echo return loss enhancement (ERLE) algorithm. In other aspects, the controller 204 calculates attenuation at a plurality of frequency bands and the echo suppressor 212 comprises a plurality of echo suppressors with a selected echo suppressor from the plurality of echo suppressors configured to suppress echo on one of the plurality of frequency bands. In still other aspects, the controller 204 generates the comfort noise by convolving a spectral image of background noise with white noise.

In some examples, the controller 204 calculates the attenuation and calculates the comfort noise in the frequency domain. In other examples, the apparatus 200 is disposed in a vehicle. In still other examples, the signal 206 is a microphone signal. In yet other examples, the signal 206 is a downlink signal received from a transmitter.

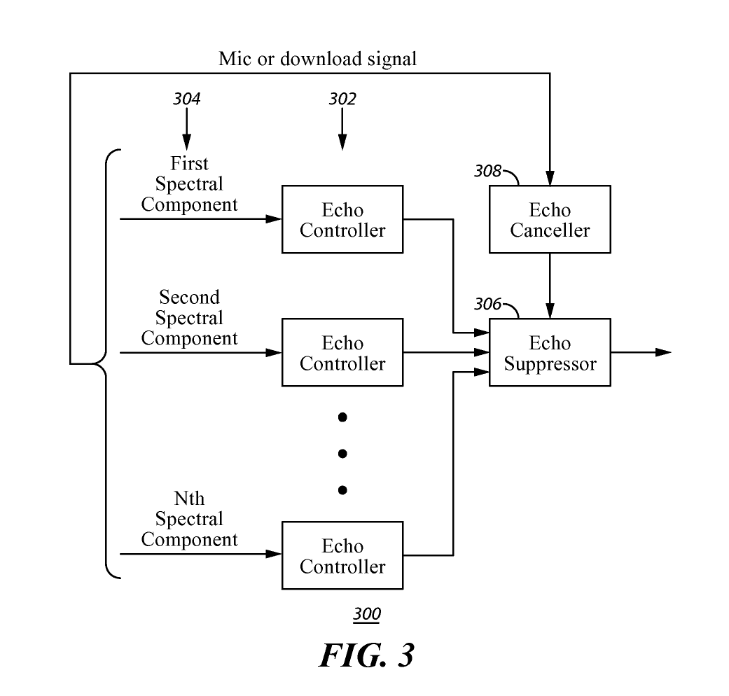

Referring now to FIG. 3, one example of an echo control system 300 is described. The system 300 includes n echo controllers 302 connected in electrically and/or logically in parallel. In one example, n=16. Other values for n are possible. The controllers 302 can be similar or identical in configuration to the apparatus 200 described with respect to FIG. 2. The operation of each of the controllers 302 has consequently been described above and will not be repeated here. At each of n frequency bands 304 and in the frequency domain attenuation/echo suppression is performed. The frequency bands are simply the FFT bins (as known to those skilled in the art). For example, 16 bands are desired with a 256 point FFT (which generates 128 real frequency bins) 8 FFT bins per frequency band are used. In other words, an estimated comfort noise is calculated at every ERLE level. The results are applied to an echo suppressor 306 which is coupled to and receives signals from an echo canceller 308. Alternatively, n separate echo suppressor can be used. In this way, each frequency or spectral band of a signal is adjusted in the frequency domain.

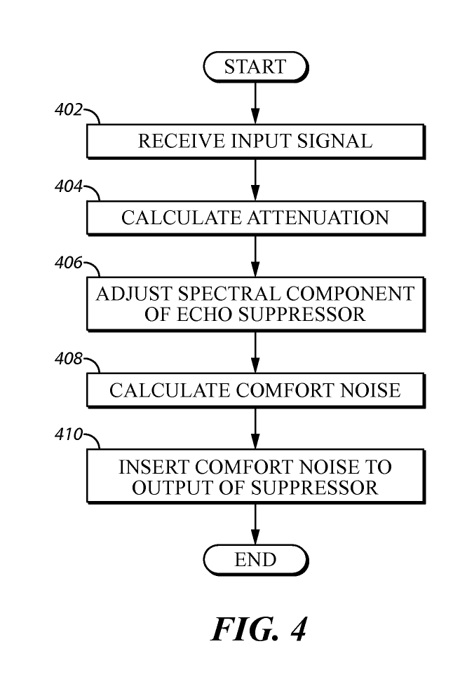

Referring now to FIG. 4, one approach for providing echo suppression is described. At step 402, an input signal from the input source is received. At step 404, an attenuation of an echo canceller filter is calculated using at least the input signal. In some aspects, the attenuation is calculated using an echo return loss enhancement (ERLE) algorithm. In other aspects, the calculation of the attenuation and the applying occur at a plurality of frequency bands and the echo suppressor comprises a plurality of echo suppressors with a selected echo suppressor from the plurality of echo suppressors configured to suppress echo on one of the plurality of frequency bands.

At step 406, a spectral component of a frequency band of an echo suppressor is adjusted to perform enhanced suppression using the calculated attenuation. In one example, each of the bands is approximately 250 Hz in length. Other examples are possible. At step 408, a comfort noise factor is calculated using at least the input signal and the calculated attenuation. At step 410, the comfort noise to the output of the echo suppressor is adjusted to obtain a modified input signal. In some other aspects, comfort noise is generated by convolving a spectral image of background noise with white noise. In still other aspects, calculating the attenuation and calculating the comfort noise are performed in the frequency domain.

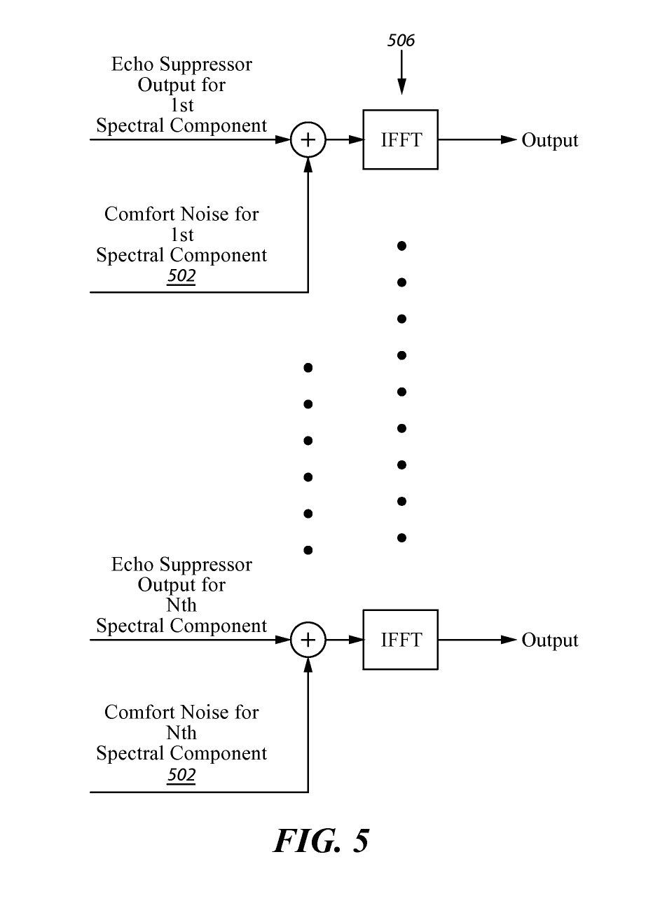

Referring now to FIG. 5, one example of inserting comfort noise into each spectral component of the output of the suppressor is shown. As shown, comfort noise 502 is generated for each spectral component of the signal 504 coming from the echo suppressor. In one example, n=16. The results are applied to IFFTs 506 and then output (e.g., as an uplink signal or as a signal used in a vehicular application).

It will be appreciated that the functions described above can be implemented by any combination of computer software and/or hardware including computer instructions stored on any type of computer or storage media.

It is understood that the implementation of other variations and modifications of the present invention and its various aspects will be apparent to those of ordinary skill in the art and that the present invention is not limited by the specific embodiments described. It is therefore contemplated to cover by the present invention any modifications, variations or equivalents that fall within the spirit and scope of the basic underlying principles disclosed and claimed herein.

What is claimed is:

1. A method for providing echo suppression for signals received from an input source, the method comprising:
receiving an input signal from the input source;
calculating an attenuation of an echo canceller filter using at least the input signal;
adjusting a spectral component of a frequency band of an echo suppressor to perform enhanced suppression using the calculated attenuation;
calculating a comfort noise factor using at least the input signal and the calculated attenuation;
applying the comfort noise to the output of the echo suppressor to obtain a modified input signal.

2. The method of claim 1 wherein the attenuation is calculated using an echo return loss enhancement (ERLE) algorithm.

3. The method of claim 1 wherein the calculation of the attenuation and the applying occur at a plurality of frequency bands and the echo suppressor comprises a plurality of echo suppressors with a selected echo suppressor from the plurality of echo suppressors configured to suppress echo on one of the plurality of frequency bands.

4. The method of claim 1 wherein comfort noise is generated by convolving a spectral image of background noise with white noise.

5. The method of claim 1 wherein calculating the attenuation and calculating the comfort noise are performed in the frequency domain.

6. The method of claim 1 wherein the echo canceller filter and the echo suppressor are disposed in a vehicle.

7. The method of claim 1 wherein the input signal is a microphone signal to be sent to an uplink receiver.

8. The method of claim 1 wherein the input signal is a downlink signal received from a transmitter.

9. An apparatus for providing echo suppression for signals received from an input source, the apparatus comprising:
an interface having an input and output, the input configured to receive an input signal from the input source;
a controller coupled to the interface, the controller configured to calculate an attenuation of an echo canceller filter using at least the input signal that is effective to adjust a spectral component of a frequency band of an echo suppressor to perform enhanced suppression using the calculated attenuation, the controller further configured to calculate a comfort noise factor using at least the input signal and the calculated attenuation and to apply the comfort noise to the output of the echo suppressor, the application of the comfort noise being effective to obtain a modified input signal at the output of the echo suppressor.

10. The apparatus of claim 9 wherein the attenuation is calculated using an echo return loss enhancement (ERLE) algorithm.

11. The apparatus of claim 9 wherein the controller calculates attenuation at a plurality of frequency bands and the echo suppressor comprises a plurality of echo suppressors with a selected echo suppressor from the plurality of echo suppressors configured to suppress echo on one of the plurality of frequency bands.

12. The apparatus of claim 9 wherein the controller generates the comfort noise by convolving a spectral image of background noise with white noise.

13. The apparatus of claim 9 wherein the controller calculates the attenuation and calculates the comfort noise in the frequency domain.

14. The apparatus of claim 9 wherein the apparatus is disposed in a vehicle.

15. The apparatus of claim 9 wherein the input signal is a microphone signal to be sent to an uplink receiver.

16. The apparatus of claim 9 wherein the input signal is a downlink signal received from a transmitter.

17. A system for providing echo suppression for signals received from an input source, the apparatus comprising:
an echo suppressor;
a echo suppression adjustment device coupled to the echo suppressor, the echo suppression device comprising:
an interface having an input and output, the input configured to receive a microphone signal;
a controller coupled to the interface, the controller configured to calculate an attenuation of an echo canceller filter using at least the microphone signal and adjust a spectral component of a frequency band of the echo suppressor to perform enhanced suppression using the calculated attenuation, the controller further configured to calculate a comfort noise factor using at least the microphone signal and the calculated attenuation, the controller further configured to add the comfort noise to the output of the echo suppressor to obtain a modified microphone signal at the output of the echo suppressor.

18. The system of claim 17 wherein the attenuation is calculated using an echo return loss enhancement (ERLE) algorithm.

19. The system of claim 17 wherein the controller calculates attenuation at a plurality of frequency bands and the echo suppressor comprises a plurality of echo suppressors with a selected echo suppressor from the plurality of echo suppressors configured to suppress echo on one of the plurality of frequency bands.

20. The system of claim 17 wherein the controller generates the comfort noise by convolving a spectral image of background noise with white noise.
